(19) United States
(12) Patent Application Publication
(10) Pub. No.: US 2009/0059872 A1
(43) Pub. Date: Mar. 5, 2009

(54) WIRELESS DYNAMIC RATE ADAPTATION ALGORITHM

(75) Inventors: Ajay MALIK, Santa Clara, CA (US); Puneet BATTA, Santa Clara, CA (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 11/848,694

(22) Filed: Aug. 31, 2007

(51) Int. Cl. H04Q 7/24

(52) U.S. Cl. 370/338

(57) ABSTRACT

A wireless switch is provided. A processor is adapted to set a radio frequency (RF) transmission speed for a wireless client based on a location of the wireless client and a signal-to-noise ratio (S/N) of a radio frequency signal received by the wireless client.

### FIELD OF THE INVENTION

The present invention generally relates to network communications, and more particularly relates to dynamically adjusting a transmission speed between wireless components of a network.

### BACKGROUND OF THE INVENTION

Wireless devices are becoming commonplace in today's society. Wireless environments may be found at home, in the workplace, and elsewhere. Many wireless networks include a wireless switch device that facilitates movement of data throughout the wireless network.

Wireless networks may have characteristics which differ from network to network. For example, the topology of a wireless environment may differ. Additionally, various physical barriers, such as walls, personnel, etc., may affect the wireless signal. Finally, differing types of wireless clients may be present, or differing applications may execute in, the network. It is desirable to implement devices in a wireless network such as a wireless switch that efficiently and dynamically facilitates the movement of data by taking the aforementioned characteristics into account.

### BRIEF SUMMARY

In one embodiment, by way of example only, a wireless switch is provided. A processor is adapted to set a radio frequency (RF) transmission speed for a wireless client based on a location of the wireless client and a signal-to-noise ratio (S/N) of a radio frequency signal received by the wireless client.

In another embodiment, by way of example only, a system for managing radio frequency (RF) transmission speed in an environment is provided. The system includes processing means for processing means for dynamically setting a radio frequency (RF) transmission speed for a wireless client based on a location of the wireless client and a signal-to-noise ratio (S/N) of a radio frequency signal received by the wireless client.

### BRIEF DESCRIPTION OF THE DRAWINGS

The present invention will hereinafter be described in conjunction with the following drawing figures, wherein like numerals denote like elements, and

FIG. 1 is an exemplary network;

FIG. 2 is an exemplary wireless switch;

FIG. 3 is a flowchart illustrating a first exemplary method for managing RF transmission speed in the network; and

FIG. 4 is a flowchart illustrating a second exemplary method for managing RF transmission speed in the network.

### DETAILED DESCRIPTION OF THE INVENTION

In a wireless network, software applications that may execute over the network may have differing needs of the network. For example, a first application may demand a limited amount of jitter, delay, and/or packet loss. However, a second application may have increased flexibility, and may allow increased jitter, delay and/or packet loss. As discussed previously, a wireless environment may differ according to various physical characteristics, such as a floor plan, or barriers that impede the wireless signal. Finally, wireless networks may include a variety of differing types of wireless clients, or devices that serve to receive the wireless signal from a host. The clients themselves may have differing needs.

In wireless networks, the transmission of data at higher rates may make the transmission more susceptible to channel noise. Channel noise may refer to undesired attributes of the wireless signal that impede the flow of data. An increased amount of channel noise may result in greater packet loss and/or a higher number of retransmissions. The transmission of data at lower rates increase the transmission time for each applicable packet of data. Depending upon the needs of the network, neither situation may be desirable.

Wireless devices such as a wireless switch have generally used a single rate adaptation algorithm for all clients without regard for the client's location, type, or a particular application associated with the client. In such a system, a first application may execute better than a second application in the network. However, the first application may not execute as well in a different environment. In one prior implementation, a rate algorithm may provide that the switch transmit data at its highest possible data transmission rate first, and then reduce speed as more transmission errors are noted. However, such an algorithm uses time and computing resources that may not be necessary if characteristics of the wireless environment (such as a location of the wireless client(s)) are known.

The following description and claimed subject matter describes an implementation of a wireless device such as a wireless switch which is configured with an adaptation algorithm that is dynamically adjusted for a specific wireless environment. The algorithm may take a variety of network characteristics into account, such as a location of a wireless client(s), a type of wireless client(s) (including various specifications associated with the wireless client), the signal characteristics associated with the wireless client(s) such as a signal-to-noise ratio (S/N), or an application associated with the client(s). Two exemplary algorithms will be further described in more detail. The implementation of such algorithms allows for dynamic rate scaling by the wireless device, resulting in less transmission errors.

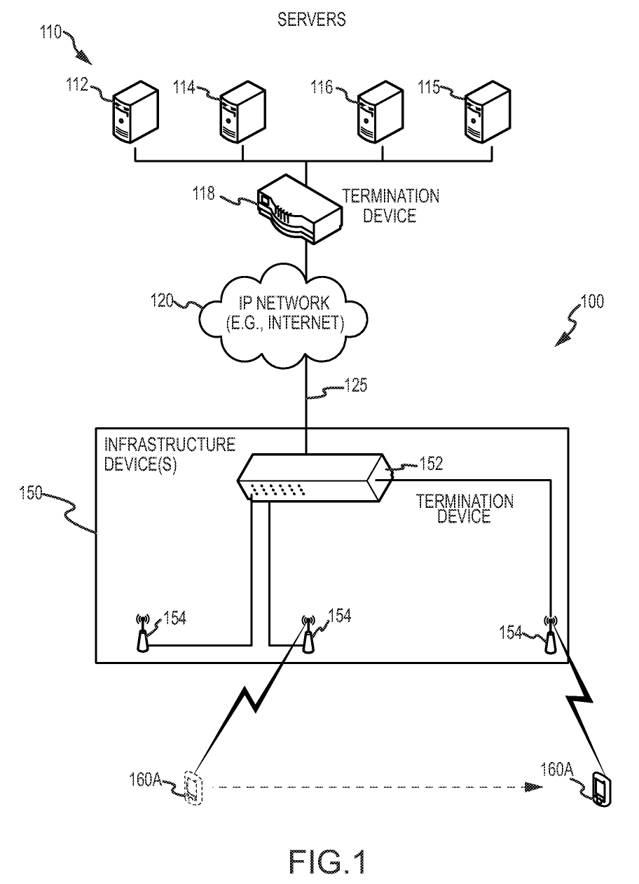

FIG. 1 illustrates an exemplary network 100 which includes Network Application Servers (NASs) 112, 114, 115, 116, a router 118, an IP network 120, infrastructure devices 150 including a wireless switch 152 and access points 154, and a wireless computing device (wireless client) 160A. A link 125 couples the router 118 to the wireless switch 152 over a network 120 which may comprise, for example, the Internet or an intranet. Although FIG. 1 illustrates a single link 125, in other practical implementations, there may be multiple logical links which couple the wireless switch 152 to the router 118.

As used herein, the term “wireless computing device” refers to a processor designed to communicate with an infrastructure device over an air interface through a wireless channel. In a general sense, the wireless computing devices are configured to receive and transmit a radio frequency signal. Accordingly, the wireless computing devices can be referred to as a “wireless client” in that the devices are clients of the wireless signal processed through the wireless switch 152 and a respective access point 154. In many cases such wireless computing devices are “handheld” and potentially mobile or “nomadic.” A wireless communication device may be any one of a number of types of mobile computing devices including, but not limited to, a hand-held or laptop devices and personal computers, tablet Personal Computers (PCs), a PC card, compact flash, personal digital assistants (PDAs), mobile telephone handsets, and the like. It will be appreciated by those skilled in the art that although FIG. 1 shows an exemplary network configuration in which one wireless computing device 160A is present, in many cases tens, hundreds or thousands of wireless computing devices can be configured as part of the network at any given time. The wireless computing device 160A can communicate with the infrastructure devices 150 in accordance with any known communication standards such as those based on IEEE 802.11 (e.g., 802.11a, 802.11b, 802.11g, 802.11e, 802.11n or 802.11s) or 802.16 standards, Bluetooth, or any other packetized communication standard or packet data protocols such as TDMA (time division multiple access). As used herein, “IEEE 802.11” refers to a set of IEEE Wireless LAN (WLAN) standards that govern wireless networking transmission methods. IEEE 802.11 standards have been and are currently being developed by working group 11 of the IEEE LAN/MAN Standards Committee (IEEE 802). Any of the IEEE standards or specifications referred to herein may be obtained at http://standards.ieee.org/getieee802/index.html or by contacting the IEEE at IEEE, 445 Hoes Lane, PO Box 1331, Piscataway, N.J. 08855-1331, USA.

In the embodiment illustrated in FIG. 1, the infrastructure devices 150 include a wireless switch 152 coupled to access points 154. As used herein, the term “wireless switch (WS)” refers to a device that channels incoming data from any of multiple input ports to the specific output port that will take the data toward its intended destination. A switch typically performs the data-link or layer 2 functions and determines, from the MAC address in each packet, which output port to use for the next part of its trip to the intended destination. In some embodiments, the switch can function as an IP switch which may also perform network or layer 3 routing functions. In one embodiment, the access point may be wireless access point that complies with the IEEE 802.11 Standard or other wireless local area network (WLAN) Standards, a Bluetooth access point, or the like. In addition, as used herein, the term “access point (AP)” refers to a device connected to a local area network (LAN) that enables remote wireless stations to communicate with the LAN. An AP is a network-capable device containing a transceiver and antenna for transmitting signals to and receiving signals from the remote stations. An AP serves as the point of interconnection between the WLAN and a fixed wire network and allows wireless communication devices to be quickly and easily connected to a wired LAN. Each AP can serve multiple users within a defined network area.

The router 118 communicates with the wireless switch 152 over the open network 120. The router 118 allows for transmitting and/or receiving of packetized audio, video and/or data information as data packets. In one implementation, the router 118 can be an IP router, where each interface on the IP router is associated with an independent IP subnet. In another implementation, the router 118 and the wireless switch 152 may be combined into a single integrated device.

In this exemplary embodiment, a number of Network Application Servers (NASs) 112, 114, 115, 116 are illustrated as being coupled to the router 118. As illustrated in FIG. 1, the NASs comprise a File Transfer Protocol (FTP) server 112, a file server 114, a DHCP server 116; however, in other embodiments other known types of application servers are typically present such as an e-mail server, an HTTP server, a Direct Connection Protocol (DCP) server, an enterprise resource planning server, an application server, proxy server, telnet server, news server, audio-video streaming server, etc.

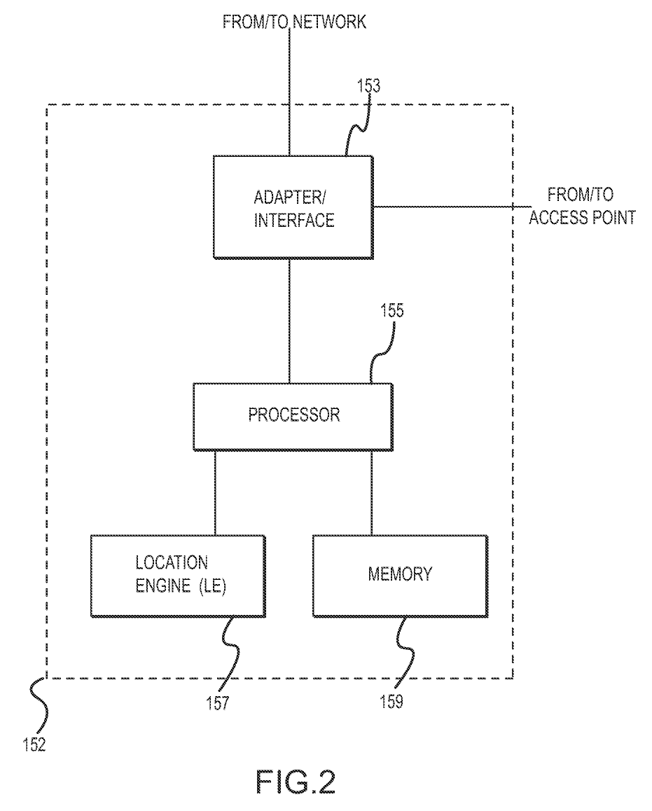

FIG. 2 illustrates an exemplary wireless switch 152. Wireless switch 152 includes an adapter and/or interface device 153 which couples the switch 152 between the IP network 120 and an access point 154 (FIG. 1). As will be appreciated, however, the access point 154 may, in some implementations, be essentially integrated into the wireless switch 152. For example, the wireless switch may include other components such as a transceiver device (not shown) which sends and receives an RF signal in place of access point 154.

Adapter 153 is coupled to a processor 155 that is configured to execute various algorithms as will be further described. Although the present embodiment depicts processor 155 integrated into switch 152, the processor 155 may be located elsewhere or configured from any point on the network 100 (FIG. 1). In the instant embodiment, processor 155 is coupled to a location engine (LE) 157 that may implement various locationing techniques, such as leveraging time-of-arrival (ToA) or time-difference-of-arrival (TDOA) data associated with a wireless client, to determine a location of the wireless client. In another embodiment, LE 157 may be integrated into processor 155 or elsewhere.

Processor 155 is shown coupled to memory 159. Memory 159 may include a variety of volatile and/or nonvolatile memories. Memory 159 may include mass storage devices such as a hard disk drive (HDD). Memory 159 may include flash memory. The exemplary algorithms which are later described may be computer program products comprising computer-readable program code. The computer-readable program code may be stored in memory 159 or elsewhere. The computer-readable program code may cause the processor 155 to execute the algorithms. The code may be embodied in compact-disks (CD), digital versatile disks (DVDs) or the like.

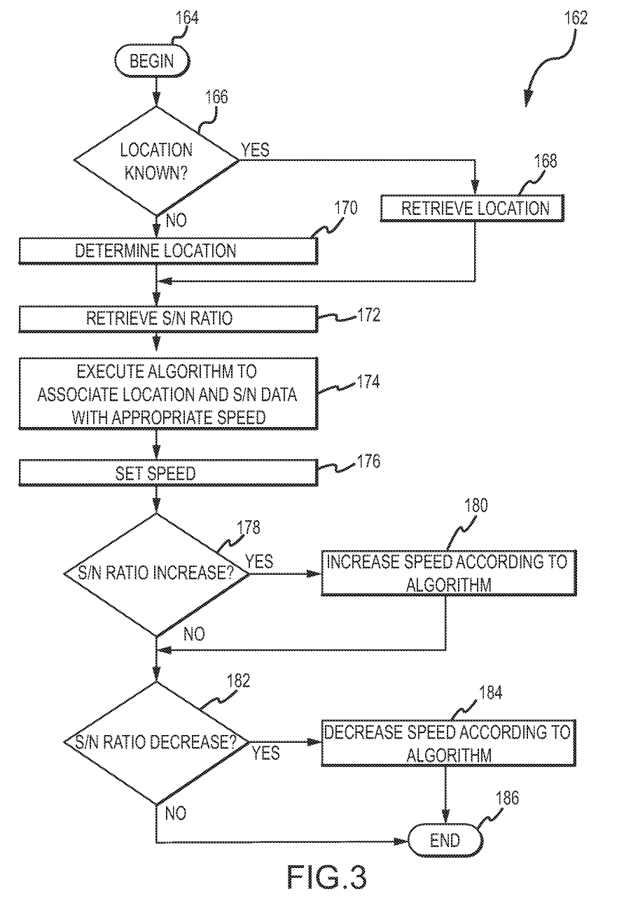

FIG. 3 is a flowchart illustrating a exemplary method 162 for dynamically setting a RF transmission speed for a wireless device such as a wireless switch. Method 162 begins (step 164) by querying whether the location of a wireless client(s) is known (step 166). The switch may query an onboard database or an external location for location information, for example. If the switch determines that the location is known, the switch retrieves the location (step 168).

If the switch determines that the location is unknown, the switch leverages its onboard location engine to determine the current location of the wireless client (step 170). For example, the switch may use various triangulation techniques incorporating the ToA or TDoA data previously described to determine the relative proximity of the wireless computing device 160 with respect to APs 154 in the network 110 (FIG. 1).

Once the location of the wireless client is determined and/or found, the switch retrieves or determines wireless communication performance metrics such as a S/N ratio associated with the wireless client. For example, the wireless communication performance metrics may be provided from APs 154 regarding wireless communication performance associated with communications between AP 154 and wireless computing device 160A (FIG. 1). The following communication performance metrics may be actively monitored by the switch: received signal strength indicator (RSSI), the aforementioned S/N ratio, interference in a respective area, load on the AP (to effectively load balance the traffic between APs), and load in the wired switch (to effectively load balance the traffic between the switches if more than one switch is deployed), or other metrics.

In a next step, the switch associates the previous information, such as performance metrics and location information, with a predetermined appropriate transmission speed (step 174). This association may take place as the switch executes an algorithm which compares the performance metrics information and location information with a set of predetermined transmission speeds. The comparison may take place using a database located as part of memory 159 (FIG. 2) or elsewhere. The comparison may use a variety of combined information. The comparison algorithm may place a greater weight on a particular performance metric. For example, a particular S/N ratio may be assigned a greater weight and/or priority than a particular RSSI. The comparison algorithm may also factor in other physical characteristics of the wireless environment, such as known barriers (e.g., walls, steel cabinets, etc.), or the presence of a number of people in a conference room at a particular time.

The switch then sets the transmission speed according to the comparison algorithm (step 176). Once the transmission speed is set, method 162 continues to actively monitor performance metrics such as the S/N ratio. If the S/N ratio increases (step 178), the switch may determine that an increased transmission speed is appropriate (step 180). If the S/N ratio decreases (step 182), the switch may decrease transmission speed accordingly (step 184). Method 162 then ends (step 186).

The increase and/or decrease in transmission speed may proceed according to a predetermined set of rules (such as the comparison algorithm, or another algorithm) which associate a particular transmission speed with a particular S/N ratio. Additionally, while not shown, an increase or decrease in transmission speed may proceed according to other rules associating other performance metrics, such as RSSI, with a particular transmission speed.

Method 162 may continue for a predetermined period of time. In one embodiment, the method 162 may continuously operate as the switch is operational. For example, the switch may continuously monitor performance metrics as well as the location(s) of wireless clients, and then dynamically adjust the transmission speed accordingly as a performance metric changes and/or the location of the wireless client changes.

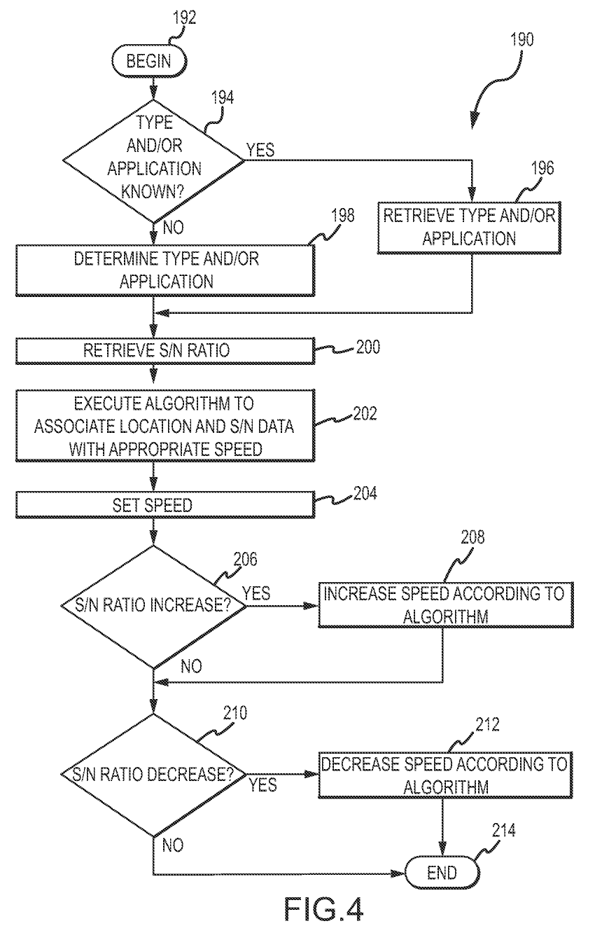

FIG. 4 is a second exemplary method 190 of dynamically setting an RF transmission speed by a wireless device such as a switch. Method 190 begins (step 192) by querying whether a client type (e.g., manufacturer and/or specification) of a wireless client is known (step 194). In addition, method 190 may query whether a specific application associated with the wireless client, such as an application which demands a particular transmission speed, lower packet losses, delay or jitter, is known (again, step 194). If the application or client type is known, the switch retrieves that information (step 196). The information may be, again, retrieved by accessing a database in a location on network 100 (FIG. 1) such as in memory 159 (FIG. 2). The information may be simply provided to the switch by the client itself or by another device on the network.

If the client type or respective application is not known, the switch may leverage any information or resources at its disposal to determine the client type or application. For example, the switch may be configured to determine a client type based on a characteristic of the data received by the wireless client. For example, the wireless client may transmit data in a certain format or in a certain style. The data may be then recognized as a signature of a particular client type. In another example, a particular application may utilize data in a certain way. Again, the data flow may indicate to the switch that a certain application is in use.

The switch retrieves various performance metrics (step 200). The performance metrics may, again, be provided or retrieved as previously described. The performance metrics may include a S/N ratio, or other performance metrics previously described.

Once the relevant metric(s) are retrieved, and the client type and/or application is understood by the switch, the switch moves to associate the performance metric(s) client type(s) and/or application(s) with the appropriate predetermined transmission speed (step 202). The transmission speed is then set (step 204).

In a similar manner to that previously described, the switch may continuously monitor such characteristics as performance metrics, client types, and applications to make adjustments to the transmission speed as necessary. For example, the switch may again monitor the S/N level associated with a particular wireless client. If the S/N level increases (step 206), the switch correspondingly increases the transmission speed (step 208). If the S/N decreases (step 210), then the transmission speed may be correspondingly decreased (step 212). Method 190 then ends (step 214), although again, the method may continuously operate as the switch is operational.

The foregoing detailed description of the invention is merely exemplary in nature and is not intended to limit the invention or the application and uses of the invention. Furthermore, there is no intention to be bound by any theory presented in the preceding background of the invention or the following detailed description of the invention.

The word “exemplary” as used above is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A wireless switch, comprising:
a processor adapted to set a radio frequency (RF) transmission speed for a wireless client based on a location of the wireless client and a signal-to-noise ratio (S/N) of a radio frequency signal received by the wireless client.

2. The wireless switch of claim 1, wherein the processor is further adapted to implement an algorithm that increases the transmission speed if the signal-to-noise ratio increases.

3. The wireless switch of claim 2, wherein the processor is further adapted to implement an algorithm that decreases the transmission speed if the signal-to-noise ratio decreases.

4. The wireless switch of claim 1, wherein the processor is further adapted to determine the location of the wireless client.

5. The wireless switch of claim 4, wherein the processor analyzes a time-of-arrival (ToA) or a time-difference-of-arrival (TDOA) parameter to determine the location of the wireless client.

6. The wireless switch of claim 3, wherein the algorithm analyzes a received signal strength indicator (RSSI) obtained from the wireless client.

7. The wireless switch of claim 1, wherein the processor receives signal-to-noise ratio data over a predetermined period of time and determines an average signal-to-noise ratio of the radio frequency signal for the wireless client.

8. The wireless switch of claim 1, wherein the processor is further adapted to set the radio frequency transmission speed based on a client type or an application associated with the wireless client.

9. The wireless switch of claim 8, wherein the processor is further adapted to determine the client type or the application associated with the wireless client.

10. The wireless switch of claim 4, further including a location engine integrated into the switch for determining the location of the wireless client.

11. The wireless switch of claim 10, wherein the processor is integrated into the location engine.

12. A system for managing radio frequency (RF) transmission speed in an environment, comprising:
processing means for dynamically setting a radio frequency (RF) transmission speed for a wireless client based on a location of the wireless client and a signal-to-noise ratio (S/N) of a radio frequency signal received by the wireless client.

13. The system of claim 12, wherein the processing means increases the transmission speed if the signal-to-noise ratio increases.

14. The system of claim 13, wherein the processing means decreases the transmission speed if the signal-to-noise ratio decreases.

15. The system of claim 12, wherein the processing means determines the location of the wireless client.

16. The system of claim 15, wherein the processing means analyses a time-of-arrival (ToA) or a time-difference-of-arrival (TDoA) parameter to determine the location of the wireless client.

17. The system of claim 12, wherein the processing means sets the radio frequency transmission speed based on a client type or an application associated with the wireless client.

18. A computer program product, comprising: a computer-usable medium having computer-readable code embodied therein for managing radio frequency (RF) transmission speed in an environment, the computer program product comprising:
a first executable computer-readable code configured to cause a computer processor to dynamically set a radio frequency (RF) transmission speed for a wireless client based on a location of the wireless client and a signal-to-noise ratio (S/N) of a radio frequency signal received by the wireless client.

19. The computer program product of claim 18, further including a second executable computer-readable code configured to cause the computer processor to increase the transmission speed if the signal-to-noise ratio increases and decrease the transmission speed if the signal-to-noise ratio decreases.

20. The computer program product of claim 18, further including a second executable computer-readable code configured to cause the computer processor to determine the location of the wireless client.
